(19) United States
(12) Patent Application Publication
(10) Pub. No.: US 2012/0226865 A1
(43) Pub. Date: Sep. 6, 2012

(54) NETWORK-ON-CHIP SYSTEM INCLUDING ACTIVE MEMORY PROCESSOR

(75) Inventors: Ki-Young Choi, Seoul (KR); Jun-Hee Yoo, Seoul (KR); Sung-Joo Yoo, Pohang-si (KR); Hyun-Chul Shin, Ansan-si (KR)

(73) Assignee: SNU R&DB FOUNDATION, Seoul (KR)

(21) Appl. No.: 13/504,923

(22) PCT Filed: Dec. 9, 2009
(86) PCT No.: PCT/KR2009/007366

§ 371 Date: Apr. 27, 2012

(30) Foreign Application Priority Data
Nov. 26, 2009 (KR) 10-2009-0115191

(51) Int. Cl. G06F 12/08

(52) U.S. Cl. 711/121; 711/130; 711/E12.024; 711/E12.038

(57) ABSTRACT

Disclosed is a network-on-chip system including an active memory processor for processing increased communication latency by multiple processors and memories. The network-on-chip system includes a plurality of processing elements that request to perform an active memory operation for a predetermined operation from a shared memory to reduce access latency of the shared memory, and an active memory processor connected to the processing elements through a network, storing codes for processing custom transaction in request to the active memory operation, performing an operation addresses or data stored in a shared cache memory or the shared memory based on the codes and transmitting the performed operation result to the processing elements.

### TECHNICAL FIELD

The present invention relates to a network-on-chip system including an active memory processor, and more particularly, to a network-on-chip system including an active memory processor for processing increased communication latency by multiple processors and memories.

### BACKGROUND ART

As the number of transistors that can be used in a chip has recently increased, there is a great increase in the number of processors in a single architecture. Due to the increased number of processors, modern SoC (System on Chip) architectures require complex communication methods. Traditional shared-wire bus is developing into crossbar-based architecture and on-chip network architecture. While the on-chip networks reduce a bottleneck of bandwidths and a long wire delay, they still have a problem of considerable communication latency. Therefore, the on-chip network requires improved methods for reducing latency between a processor and a memory. Although many methods have been proposed to reduce on-chip communication latency, there is intrinsic limitation in reducing the on-chip communication latency due to a communication distance, which is an unavoidable physical limit. Therefore, in the current SoC architectures, attempts are made to reduce or conceal the communication latency by caching, prefetching, smart communication scheduling, or intelligent network architecture.

### DISCLOSURE OF THE INVENTION

In order to overcome the above-mentioned shortcomings, the present invention provides a network-on chip system including an active memory processor, which can replace computation of a plurality of memory access transactions and related local processing elements with a smaller number of high-level transactions and memory-approximation computation on an on-chip network.

According to an aspect of the invention, there is provided a network-on-chip system including a plurality of processing elements that request to perform an active memory operation for a predetermined operation from a shared memory to reduce access latency of the shared memory, and an active memory processor connected to the processing elements through a network, storing codes for processing custom transaction in request to the active memory operation, performing an operation addresses or data stored in a shared cache memory or the shared memory based on the codes and transmitting the performed operation result to the processing elements.

Wherein the processing element requests for the active memory operation by generating a request packet including a network address of the active memory processor to execute the active memory operation, a network address of a processing element having requested the active memory operation, a start address of a subroutine code for executing the active memory operation, and a parameter used as argument related to the subroutine code to be executed, and transmitting the generated request packet to the active memory processor.

Wherein the active memory processor receives the request packet, executes the active memory operation using the code start address and the parameter and generates a response packet including information on the execution result of the active memory operation to then transmit the response packet to the processing element.

Wherein the active memory processor further includes a code memory for storing subroutine codes for executing the active memory operation, a request buffer for queuing a request for the active memory operation received from the processing element, and a response buffer for buffering the response packet and transmitting the buffered response packet to the processing element.

Wherein when an immediate response to the result of the active memory operation is not received from the shared cache memory, the active memory processor determines whether or not data for executing the active memory operation is written in the shared cache memory and whether or not the response data for the result of the active memory operation is generated, and cancels execution of the active memory operation based on the determination result.

Wherein when the execution of the active memory operation is cancelled, the active memory processor returns the request for the active memory operation to the request buffer.

Wherein the request buffer comprises: a packet buffer for queuing a payload of the request packet; a pointer buffer management table including a position of a first flit of the packet buffer, the number of valid flits and the next slot entry corresponding to the next pointer; and a packet entry table including a priority of the request packet and a position of a first flit of the pointer buffer management table.

Wherein the processing elements include private cache memories, and when a private cache miss occurs, the private cache memories makes a request for an active memory operation for processing the private cache miss to the active memory processor and receives the private cache missed data by the operation of the active memory processor.

### ADVANTAGEOUS EFFECTS

According to one embodiment of the present invention, performance of pipelined executions can be improved with a gentle area overhead in a network interface of memory tiles.

In addition, according to one embodiment of the present invention, since operations greatly affecting memory latency can be directly executed in a memory side, a need for prefetching can be reduced.

In addition, according to one embodiment of the present invention, an active memory processor positioned in the vicinity of a memory and executing an active memory operation is implemented, thereby replacing computation of a plurality of memory access transactions and related local processing elements with a smaller number of high-level transactions and memory-approximation computation on an on-chip network.

### BRIEF DESCRIPTION OF THE DRAWINGS

The objects, features and advantages of the present invention will be more apparent from the following detailed description in conjunction with the accompanying drawings, in which:

FIG. 1 is a diagram of a network-on chip system including an active memory processor (AMP) according to an embodiment of the present invention;

FIG. 2 illustrates topology of an overall network-on chip system according to another embodiment of the present invention;

FIG. 3 is a block diagram illustrating an internal structure of a processing element shown in FIGS. 1 and 2;

FIG. 4 is a block diagram illustrating an internal structure of a memory tile shown in FIGS. 1 and 2;

FIGS. 5 and 6 illustrate a difference in execution time of an active memory operation (AMO) according to an embodiment of the present invention;

FIG. 7 illustrates an exemplary execution of the AMO according to an embodiment of the present invention;

FIG. 8 illustrates a second embodiment (handler initiation) for initiating the active memory operation;

FIG. 9 illustrates revocation and retry of the AMO according to an embodiment of the present invention;

FIG. 10 illustrates an example of instruction sets for performing an AMO using an AMP;

FIG. 11 illustrates exemplary codes for the AMP;

FIG. 12 illustrates a pipeline structure of the AMP according to an embodiment of the present invention; and

FIG. 13 illustrates an example of a data structure of a request buffer.

### BEST MODE FOR CARRYING OUT THE INVENTION

Hereinafter, embodiments of the present invention will be described in detail with reference to the accompanying drawings.

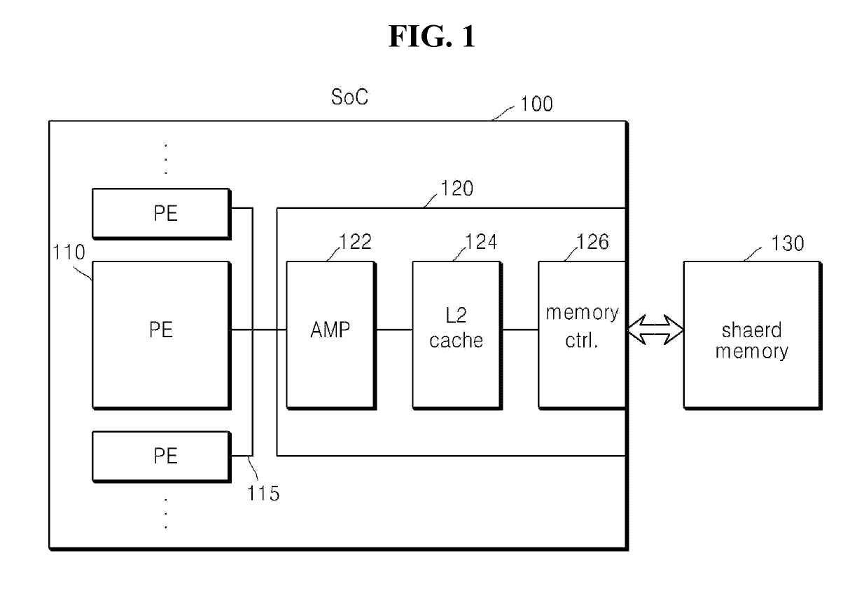

FIG. 1 is a diagram of a network-on chip system 100 including an active memory processor (AMP) according to an embodiment of the present invention.

Referring to FIG. 1, the network-on chip system 100 adopts an approach for attempts at reducing the number of transactions in an on-chip network 115 rather than communication latency between a processing element (PE) 110 and memories 124 and 130. In other words, the network-on chip system 100 adopts an active memory operation (AMO) for replacing a plurality of single memory read/write operations with a high-level operation. The purpose of performing an AMO is to control an active memory processor (AMP) to perform relatively simple computations, thereby reducing the number of communications between the PE 110 and the memories 124 and 130.

In order to perform the aforementioned operations, the network-on chip system 100 includes a plurality of processing elements 110 and a memory tile 120.

In order to reduce the access latency of a shared memory, the processing elements 110 transmit a request for the AMO to the AMP 122 so that the shared memory performs a predetermined operation.

The processing element (PE) 110 generates a request packet including a network address of the AMP 122 to execute the AMO, a network address of the processing element 100 having requested the AMO, a start address of a subroutine code for executing the AMO, and a parameter used as argument related to the subroutine code to be executed, and transmits the generated request packet to the AMP.

Here, the network address of each of the AMP 122 and the processing elements 110, start address and additional parameter may be interleaved to a header of the request packet.

The memory tile 120 includes the AMP 122 and a memory controller 126. In addition, the memory tile 120 may further include a shared cache memory 124. The shared cache memory 124 may include a level 2 (L2) cache memory, a level 3 (L3) cache memory or a level 4 (L4) cache memory. For convenient sake of explanation, the following description is made using the L2 cache memory as an exemplary shared cache memory.

The AMP 122 is connected to the processing elements 110 through the network 115. In addition, the AMP 122 stores codes for processing a custom transaction previously determined by a user in response to the request for the AMO from the processing elements 110.

If a request for the AMO is received from the processing elements 110, the AMP 122 performs an operation for the address or data stored in the L2 cache memory 124 or the shared memory 130 based on the above-described codes and transmits the operation result to the processing elements 110.

For example, the AMP 122 receives the request packet including a network address of the AMP 122 to execute the AMO, a network address of the processing element 100 having requested the AMO, a start address of a subroutine code for executing the AMO, and a parameter used as argument related to the subroutine code to be executed. Then, the AMP 122 executes the AMO using the code start address and the additional parameter and generates a response packet including information on the execution result of the AMO to then transmit the response packet to the processing elements 110.

In order to perform the above-described operation, the AMP 122 may further include, for example, a code memory for storing subroutine codes for executing the AMO, a request buffer for queuing a request for the AMO received from the processing elements 110, and a response buffer for buffering the response packet and transmitting the buffered response packet to the processing elements 110.

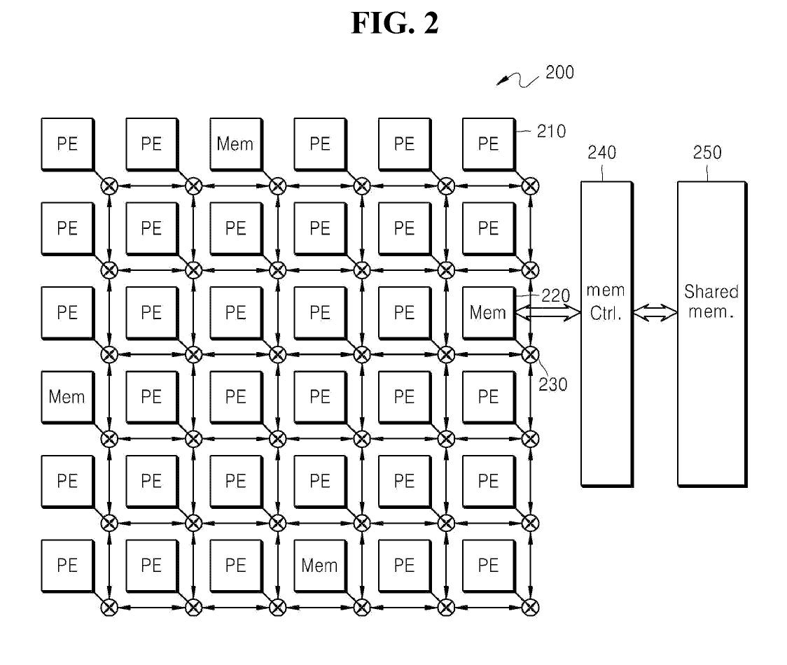

FIG. 2 illustrates topology of an overall network-on chip system according to another embodiment of the present invention.

Referring to FIG. 2, the overall network-on chip system 200 includes a plurality of processing elements 210 (e.g., 32 processing elements) and a plurality of memory tiles 220 (e.g., 4 memory tiles). The respective processing elements and memory tiles are connected to a network by a router 230. The memory tiles 220 are connected to the shared memory controller 240 and the shared memory 250. Alternatively, the memory tile 220 may further include the shared memory controller 240. The processing elements 210 and the memory tiles 220 are described with reference to FIGS. 1, 3 and 4, and further explanations thereof will be omitted.

In this embodiment, the network-on chip system 200 may adopt a simple X-Y routing method, rather than an out-of-order dynamic routing method, which is because the out-of-order dynamic routing method may generate an additional area overhead according to the buffer request.

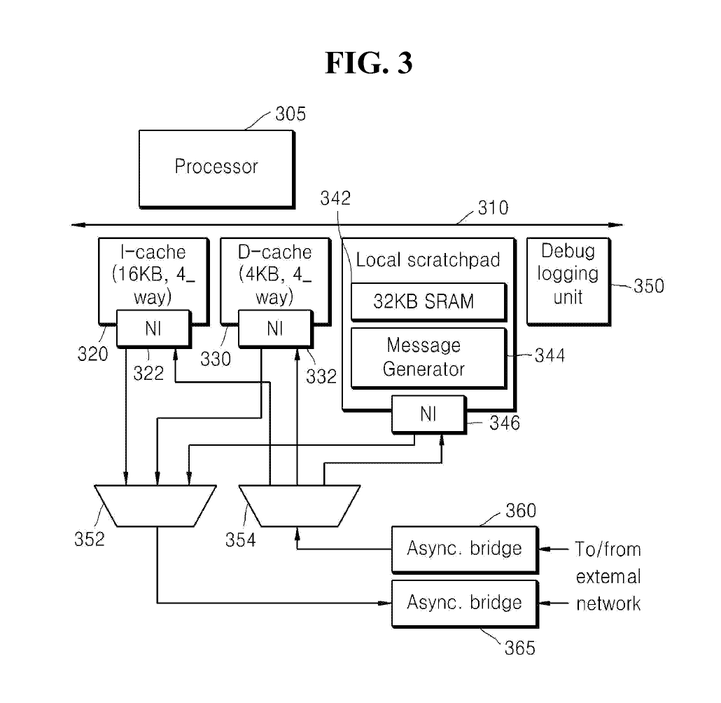

As shown in FIG. 3, each of the processing elements 210 may include an L1 cache memory including a local scratchpad memory storing codes for performing an AMO (see a 32 KB SRAM 342 of FIG. 3) and generating a request packet to be transmitted to (see a message generator 344 of FIG. 3), an I-cache 320 and a D-cache 330, and a master processor 305 controlling a predetermined processing function to be performed through the AMO. In addition, each of the processing elements 210 may further include a debug logging unit 350 for processing debugging when the AMO is performed. Each of the scratch pad memory 340, the I-cache 320 and the D-cache 330 includes a network interface (NI) for data input/output and is connected to the network through switches 352 and 354 and asynchronous bridges 360 and 365. The aforementioned blocks are connected to each other through an internal bus 310.

Referring back to FIG. 2, one of the memory tiles 220 may include an ROM block for storing codes for executing an AMO and read-only data, and the other 3 memory tiles may include an L2 cache and a shared memory controller (e.g., a DDR2-SDRAM controller).

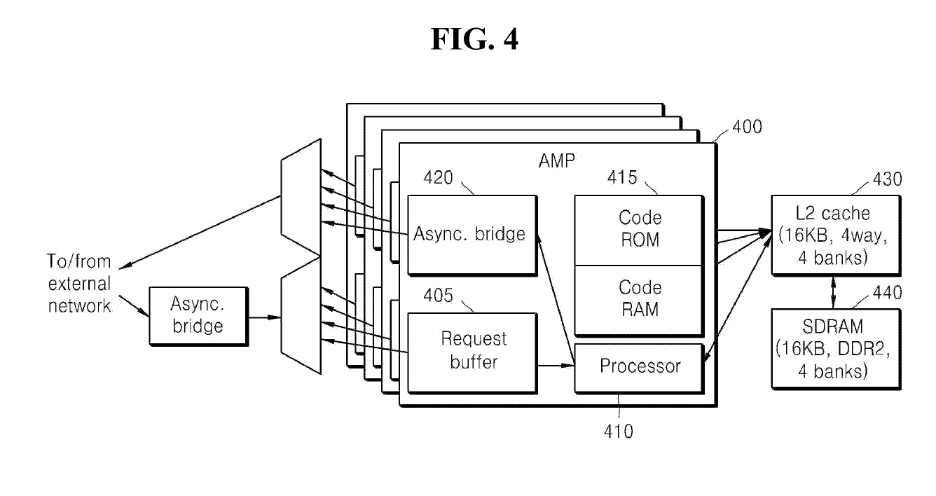

FIG. 4 is a block diagram illustrating an internal structure of a memory tile shown in FIGS. 1 and 2.

Referring to FIG. 4, an input port of the memory tile is connected to a switch for sending input packets to a request buffer queuing a small number of flits (each of flow control digits (flits) being a minimum unit for data transmission over a network).

The memory tile includes a plurality (e.g., 8) of AMPs 400 (for brevity, only 4 AMPs are illustrated in FIG. 4), and each of the AMPs 400 includes a request buffer 405 for storing a request packet, an asynchronous bridge 420 operating as a response buffer for storing response data to be transmitted to the processing element 210, an AMP processor 410, and a code memory 415 for storing subroutine codes to be executed. The request buffer may store, for example, 64 bit flits or 8 packets. The request buffer may be designed using a single dual-port SDRAM block, which reduces an area overhead.

The request buffer 405 is connected to the AMP processor 410. The AMP processor 410 receives request packets from the request buffer 405 and instructs the request buffer 405 of how to process the request packets. Then, the response packets generated by the AMP processor 410 are queued in a small capacity (e.g., a 8 flip depth) FIFO 420 to then be transmitted to the processing element 210. The response packets include data regarding an execution result of the AMO requested from the processing element 210 and data regarding whether the requested AMO has been normally performed.

The AMP processor 410 is connected to the code memory including, for example, 1024 64-bit words. Here, 128 words may be allocated to one ROM to execute basic functions (basic load/store, mutex processing, barrier processing, etc.) and the remaining 896 words may be allocated to an SRAM to be used when programming codes for a user to execute a predetermined AMO. An SRAM region may be programmed such that the processing element 210 transmits a request for an AMO to write a predetermined code in the code memory.

All AMPs may be connected to an L2 cache controller 430 via a local crossbar bus. The L2 cache controller 430 is connected to a shared memory controller 440. In order to interface the AMPs and the L2 cache controller 430, a bus protocol can be designed for a simple AMP. For example, the bus protocol may offer 8 memory operations: normal store, store and immediate flush, store and immediate evict, store and non-loading from cache, normal load, load and immediate evict, non-blocking load (to be described later) and prefetching.

Meanwhile, since the AMPs are shared resources, they may be designed to execute short subroutines having a large number of communication routines, rather than for the AMPs to directly execute a full-scale application AMP. Therefore, the AMP uses special instruction sets optimized to memory access and network packet generation, thereby storing codes in smaller SRAM blocks.

Additionally, the AMP 400 may be designed to minimize communication latency (for example, a time required for a given number of operations to be completely finished). Therefore, a long pipeline is not desirably employed. Likewise, complicated out-of-order engines are not desirably employed, either. The out-of-order engines add a plurality of pipeline steps for scheduling and reordering instructions. Therefore, static scheduling methods, such as a VLIW structure, may be employed.

In a large chip multiprocessor structure, only a limited number of AMPs can be integrated into a single memory block. Although a large number of AMPs may be integrated into one memory block, a large local bus is required between the AMP and a memory subsystem, increasing communication latency between the AMP and the memory subsystem. Therefore, the AMP is preferably used only for processing operations including tight latency restriction and frequent memory accesses.

In addition, the AMP should maximize a memory access processing amount. To this end, at least one memory access operation is preferably executed for every cycle. Therefore, the AMP requires pipelined executions of at least 4 operations: a memory access, an address computation, a condition branch, and an address comparison for boundary check.

The AMP should have a set of lots of instructions for data accessing while having a small number of instructions for data computation. For example, while floating-point computation, multiplication or division can be omitted, complicated address computation methods or bitwise operations need to be implemented.

Since the AMP intends to be directly connected to the shared memory, it should include many features for controlling behaviors of the memory subsystem. For example, the AMP should simultaneously output many load/store instructions and a variety of memory control instructions such as cache management and prefetching operations. However, excessively complicated instructions and computations requiring too many customizations may add a considerably high overhead between the AMP and the shared memory, which may be unnecessary.

In addition, the AMP may have instructions for controlling the shared memory or the L2 cache memory. For example, if the AMP is connected to the L2 cache controller, it may have instructions for initiating cache management operations such as flushing of a line or prefetching data from the shared memory (e.g., SDRAM).

Eventually, the AMP controls the L2 cache controllers and the SDRAM controller, and an application designer may optimize memory-concentrated operations using the AMP.

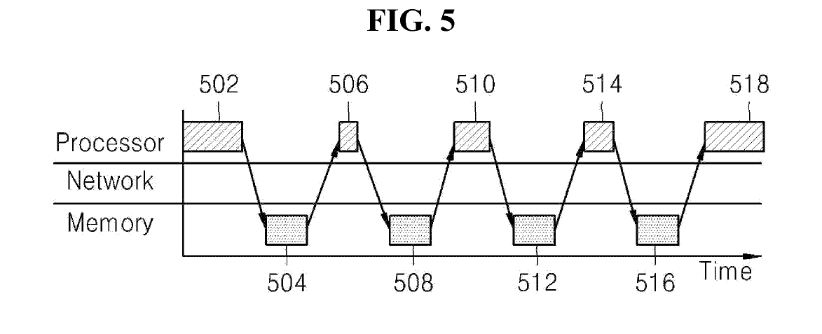

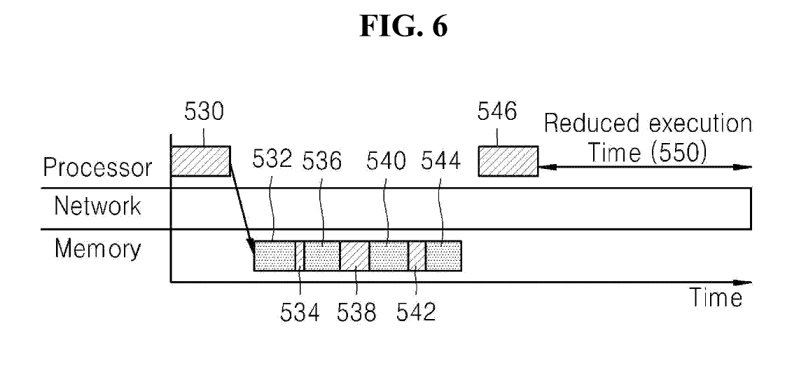

FIGS. 5 and 6 illustrate a difference in execution time of an active memory operation (AMO) according to an embodiment of the present invention.

Referring to FIG. 5, when codes for executing a predetermined function by a conventional method are executed only at processing elements 502,506,510,514 and 518, the predetermined function needs to be performed by 4 memory accessing routines 504, 508, 512 and 516, the 4 memory accessing routines cause communication latency, thereby increasing execution cycles.

Referring to FIG. 6, according to an embodiment, computations for generating frequent (or irregular) memory accesses (given codes) are controlled to be executed in the AMP 122 positioned in the vicinity of the memory (534, 538 and 542). Therefore, as shown in FIG. 6, the number of transactions on the on-chip network can be reduced from 4 to 1. Therefore, a memory stall time for executing a predetermined function and the overall traffic on the on-chip network can both be reduced (550).

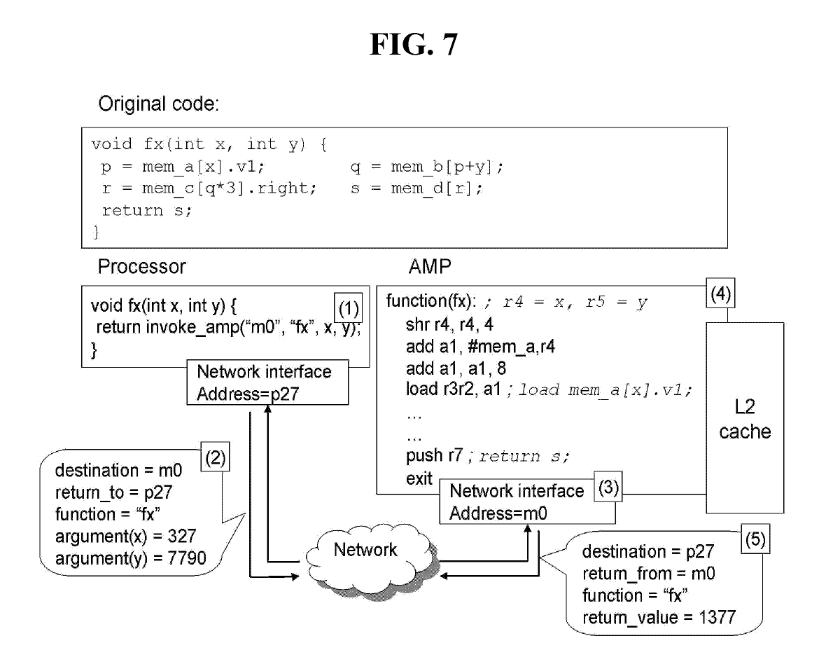

FIG. 7 illustrates an exemplary execution of the AMO according to an embodiment of the present invention.

Referring to FIG. 7, an exemplary execution of the AMO according to an embodiment of the present invention will be described.

1) An active memory operation (AMO) includes a function such as ‘search the largest integer from a linked list’ initiated by, for example, software program operating in the processing element.

2) A processing element (PE) generates a request packet of AMO, including AMP code start address and additional parameters.

3) When the request packet of AMO reaches the AMP, the AMP decodes a header of the request packet using a dedicated packet decoder. The request packet header includes 1) network address of AMP for routing and network address of PE for generating AMO, 2) a AMP code start address including a subroutine to be executed, and 3) additional parameter(s) used as an argument related to the AMP code to be executed to be used as first values of registers.

The packet decoder sets a program counter (PC) and first registers according to content of the request packet and prepares a header of routing information of the request packet using the response packet.

4) The AMP starts code execution using the AMP code start address and the parameter received from the processing element. The AMP reads a code and generates output packets using a set of instructions to be described later. Then, the AMP reads data from the shared memory or writes data into the memory using load/store instructions.

5) After completing the execution, the AMP generates the response packet and returns the same to the processing element.

Hereinafter, an exemplary method for the processing element initiating the AMO will now be described.

### 1) First Embodiment (Normal Initiation)

Normal initiation is performed using an AMO generator of a processing element in order to request for AMO function. A master processor of the processing element generates an AMO request for initiating the AMP and transmits the same to the AMP. The master processor waits until a response to the AMO request reaches the AMO generator. A detailed AMO method is described with reference to FIG. 7 and additional description will be omitted.

### 2) Second Embodiment (Handler Initiation)

The processing element 110 may include a private cache memory different from the shared cache memory 124. The private cache memory may include a level 1 (L1) cache memory. For convenient sake of explanation, the following description is made using the L1 cache memory as an exemplary shared cache memory. When a L1 cache miss occurs, the L1 cache memory may send an AMO request to the AMP to process the L1 cache miss and may receive L1 cache missed data by the operation of the AMP.

In the second embodiment, the AMP operates implicitly by the L1 cache. In the second embodiment, the AMP is used as a ‘L1 cache miss handler’. That is to say, when an L1 cache needs to read or write as an L2 cache, the L1 cache operates the AMP instead of requesting for L2 cache access. In this way, the software designer may employ various methods case by case for loading from the L2 cache or flushing to the L2 cache.

In order to implement the second embodiment, for example, D-cache L1 controllers have three sets of 4 registers, that is, a handler base register n (HBRn), a handler limit register n (HLRn), a handler read instructions register n (HRCRn), and a handler write instructions register n (HWCRn), where n is 0, 1, 2, or 3. The HBRn and HLRn specify lower and upper boundaries of an address scope of each block n. The HRCRn and HWCRn specify an initiated AMO operation when a shared memory access operation, instead of a general read or write operation, is required for the block n. Whenever the L1 cache needs to generate a memory access request, a base address is compared with HBRn and HLRn. If the base address can be applied to the block n, operations specified to the HRCRn and HWCRn are executed.

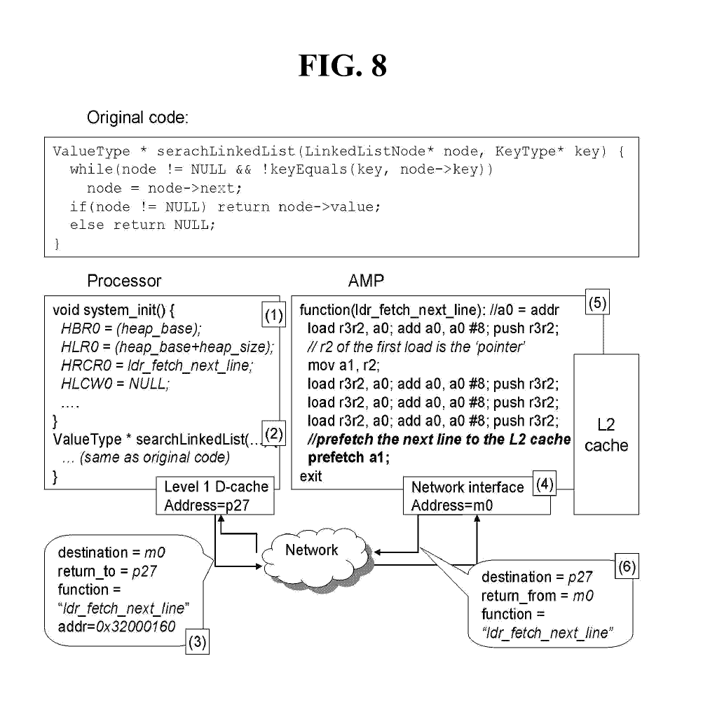

FIG. 8 illustrates a second embodiment (handler initiation) for initiating the AMO.

The second embodiment (handler initiation) for initiating the AMO will be described referring to FIG. 8.

1) During system initialization, handler registers of the L1 cache controller are initialized by codes of the master processor. The handler registers specify a heap for nodes in a linked list are handled by the AMO.

2) The PE executes codes for executing a search of the linked list.

3) The PE may output a L1 cache miss while executing the search of the linked list. In this case, the L1 cache controller outputs the AMO for processing the L1 cache miss to the AMP, rather than the PE outputting a load operation of a general cache line

4) If the AMO reaches the AMP, the AMP decodes the AMO together with a general AMO.

5) The AMP executes a decoded code. In this case, the decoded code allows an L1 cache missed line to be loaded and the loaded line is sent back to the L1 cache controller. The AMP prefetches a position of the next node in the linked list from the shared memory to the L2 cache memory.

6) The response packet is returned to the PE. The L1 cache controller fills the missed line and the PE evicts the corresponding execution.

Hereinafter, an exemplary method for more effectively performing the AMO using the AMP will now be described.

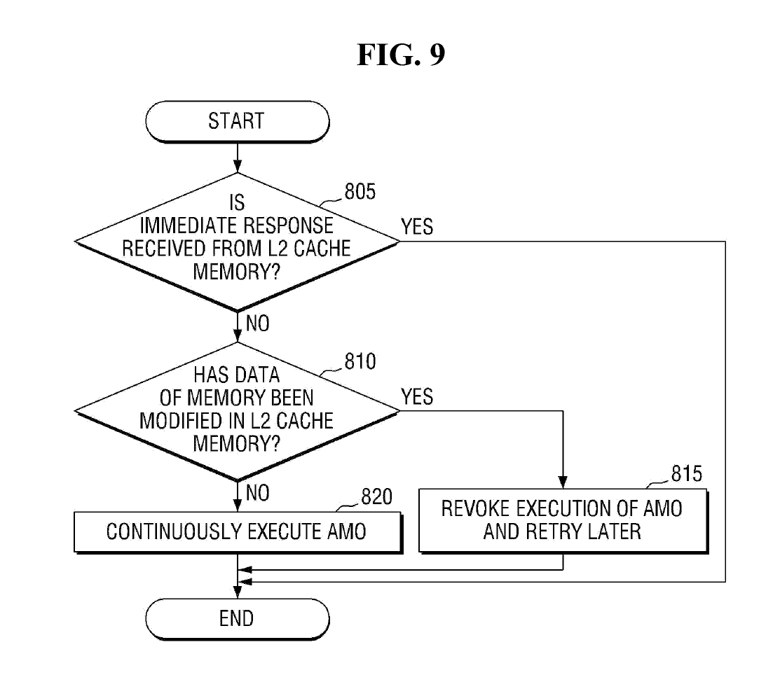

FIG. 9 illustrates revocation and retry of the AMO according to an embodiment of the present invention.

When the AMO is used, processing a large number of transactions is quite a challenge. Apparently, a large number of simultaneous requests will be transmitted from PEs to the AMP due to a large number of PEs. The network may transfer a large number of request packets, and the request buffer may queue the large number of request packets in queues. In addition, the L2 cache controller may output the large number of simultaneous requests.

When the L2 cache controller cannot send an immediate response to the AMP (for example, when there are L2 cache misses), the AMO being processed should be reserved until the L2 cache controller sends a response to the AMP. Here, the AMP may sit idle until the response is sent from the L2 cache controller. Alternatively, the request buffer starts a new AMO process, and states of the previous AMOs can be maintained in some memories.

The first choice may be simply implemented. However, when L2 cache miss latency is high and a high bandwidth is required, performance deterioration may be caused. This is because AMPs should sit idle until a response is received from the L2 cache controller.

The second choice may not cause performance deterioration but system state maintenance is costly. In particular, when the L2 cache memory latency is high, the number of AMOs whose states need to be maintained may increase.

Therefore, AMP codes capable of safely revoking all transactions may be specified, instead of maintaining perfect AMOs.

That is to say, as shown in FIG. 9, the AMP 122 determines whether an immediate response to the AMO result is received from the L2 cache memory (Step 805). If it is determined that the immediate response is not received (that is, when the L2 cache cannot perform immediately a requested operation), the AMP 122 determines whether data for performing an AMO is modified and written in the L2 cache memory or response data for the AMO result is generated to determine whether AMO execution can be terminated or not (Step 810). If it is determined that the data of the L2 cache memory has not been modified (for example, by a data write operation or response data), the AMP 122 revokes AMO execution and then the AMP 122 may return a request for AMO to the request buffer, so that the revoked AMO operation is rescheduled until it is determined that the corresponding request packet is ready for execution (Step 820). As a result, the AMP 122 may not necessarily store perfect transaction states in compensation for a slightly more complicated AMP programming together with gentle performance overhead.

Meanwhile, if data of the L2 cache memory has been modified, the AMP 122 continuously executes the AMO being currently executed (Step 815) and completes the execution of the corresponding AMO to then be evicted.

The revocation and re-try methods may be implemented by completing transactions by jumping to A_RETRY or A_SLEEP while using load register non-blocking (LDRNB) instructions to be described later.

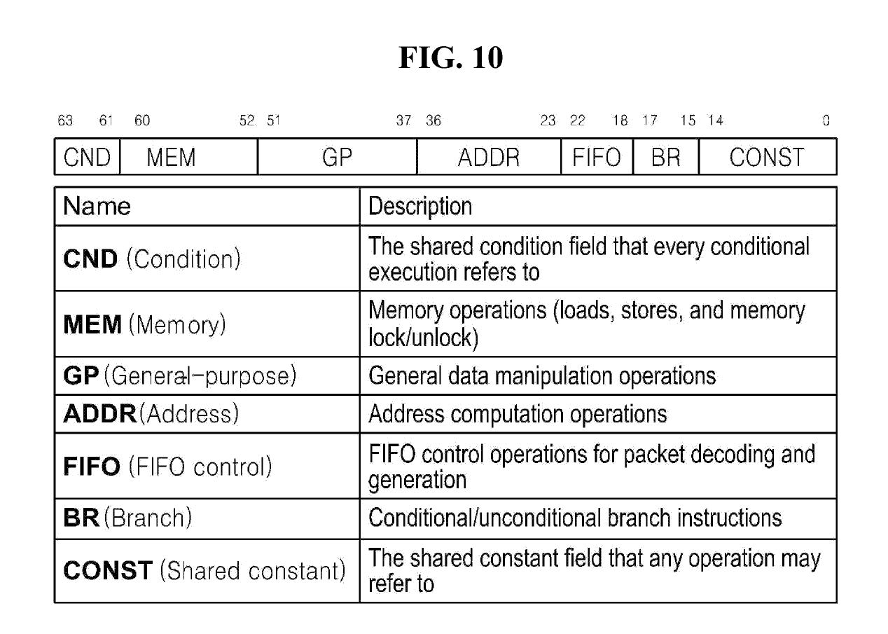

Next, an example of instruction sets for performing an AMO using an active memory processor (AMP) will be described with reference to FIG. 10. FIG. 10 illustrates an example of instruction sets for performing an AMO using an active memory processor (AMP).

Instruction words have a size of 64 bits, and each of the instruction words includes a memory access operation, a data processing instruction, an address computation instruction, a FIFO control instruction for reading request packets and generating the response packets, and a branch instruction. Each operation may be implemented under a predetermined condition, and all of the instructions share the same condition in the same instruction word.

In order to save an address encoding space, all of the instructions share the same instant value (constant) fields because immediate fields are not frequently used. In addition, a data computation operation or an address computation operation may be replaced by a comparison operation.

For example, a GP operation may include an operation for correcting registers R4 to R7, logic operations such as addition, subtraction or multiplication, a bitwise operation, a comparison operation (to correct condition flags), and operations for facilitating the bitwise operation.

An address (ADDR) operation may include, for example, a 32-bit logic operation. For a fast ADDR operation, ‘comparison and increment’ of comparing and calculating operations at the same cycle can be supported.

A branch operation supports a simple condition branch. When the AMP jumps to a predefined address (without an executable code), execution of AMO is terminated and the AMP returns to a standby state in which it waits for more request packets.

Four predefined addresses are:

A_EXIT: AMO is simple terminated.

A_RETRY: Execution of AMO is revoked and then fed back to a request buffer.

A_SLEEP: Execution of AMO is revoked and then fed back to a request buffer. However, A_SLEEP is different from A_RETRY in that AMOs revoked by A_SLEEP are not re-scheduled unless they are waked by some other AMOs. That is to say, it is not necessary to retry A_SLEEP unless there is a change in the condition.

A_WAKE: AMO is terminated and all standing-by packets in an A_SLEEP condition are waked.

The AMOs are typical load/store operations to access a memory subsystem. In addition to the typical load/store operations, there are some additional instructions:

LDREV/STREV: Load/store, then flush and evict data from cache controller.

STRF: After data is stored, cache line is flushed.

PREFETCH: Data of memory subsystem is loaded but a request is made to prefetch data to cache.

STRNL: Data is stored but is not loaded in cache line.

LDRNB: ‘Non-blocking load’ is used for revocation and retry of AMO.

The instruction is operated in the same manner as ordinary load instruction, but a load request is not immediately process (for example, due to an L2 cache miss). The AMO is immediately terminated and a request packet is returned to request queue. The purpose of this instruction is to offer a safe state in which the AMO can be safely terminated, rather than a standby state in which completion of a memory operation is waited for.

OCK/UNLOCK: The local bus is locked or unlocked. LOCK is automatically released when the AMO having locked local bus is completed.

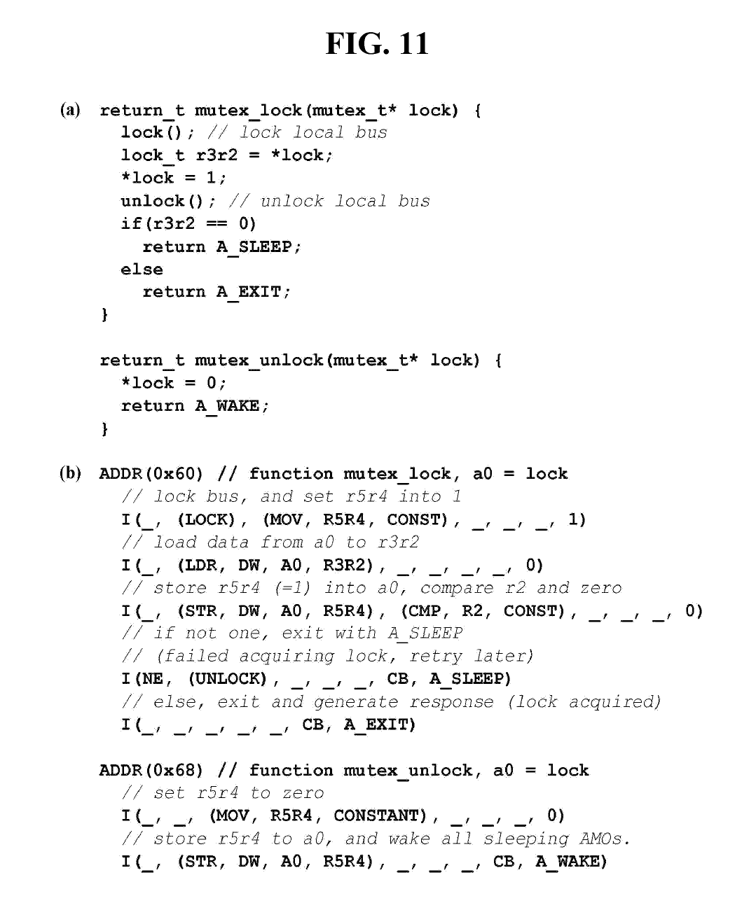

FIG. 11 illustrates exemplary codes for the AMP. Specifically, FIG. 11(a) illustrates C implementation of algorithms corresponding to mutex lock & unlock, and FIG. 11(b) illustrates AMP machine code implementation of algorithms corresponding to mutex lock & unlock.

FIGS. 11(a) and 11(b) illustrate how to use A_SLEEP for thread synchronization. While locking, the AMO returns to A_SLEEP when it fails in acquiring LOCK. The sleeping AMO is waked when LOCK is released by another AMO. A_WAKE wakes all sleeping AMOs, one of the waked AMOs tries acquisition of LOCK and the other AMOs return to Sleep states.

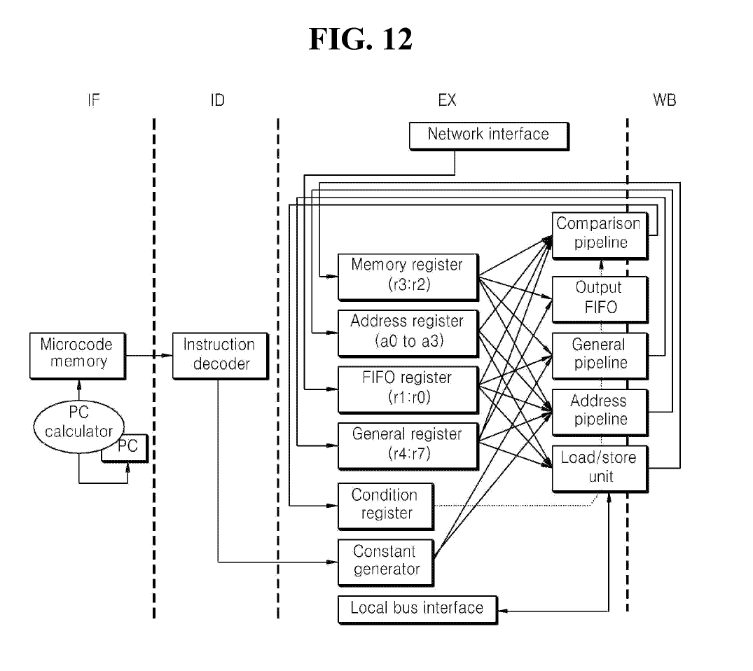

FIG. 12 illustrates a pipeline structure of the AMP according to an embodiment of the present invention.

The AMP is a simple 4-step VLIW processor. At step of IF (Instruction Fetch), code addresses are generated and input signals of a code memory are driven. At step of ID (Instruction Decode), outputs of the code memory are decoded and all appropriate control signals are generated.

All operations are waked at step of EX (Execution). Since there are no multi-cycle operations, a relatively simple pipeline structure is achieved. Then, the executed operation is terminated at step of WB (Writeback) in which execution results are written back to register files.

Hereinafter, a method of handling the request buffer will be described.

Since the AMP has characteristics related to transaction scheduling, requirements of the request buffer may become complicated. The AMP may revoke a received AMO request and may return the received AMO request to request queue. Therefore, the request buffer should process the following cases properly.
Since AMOs may have request packets of different lengths, it is necessary for the request buffer to process the request packets of different lengths.
In order to support A_WAKE and A_SLEEP, the request buffer should be able to output packets in a different sequence from an entry sequence. Therefore, the request buffer cannot be designed with FIFO but can store as many packets as possible (for example, dual-port SDRAM).

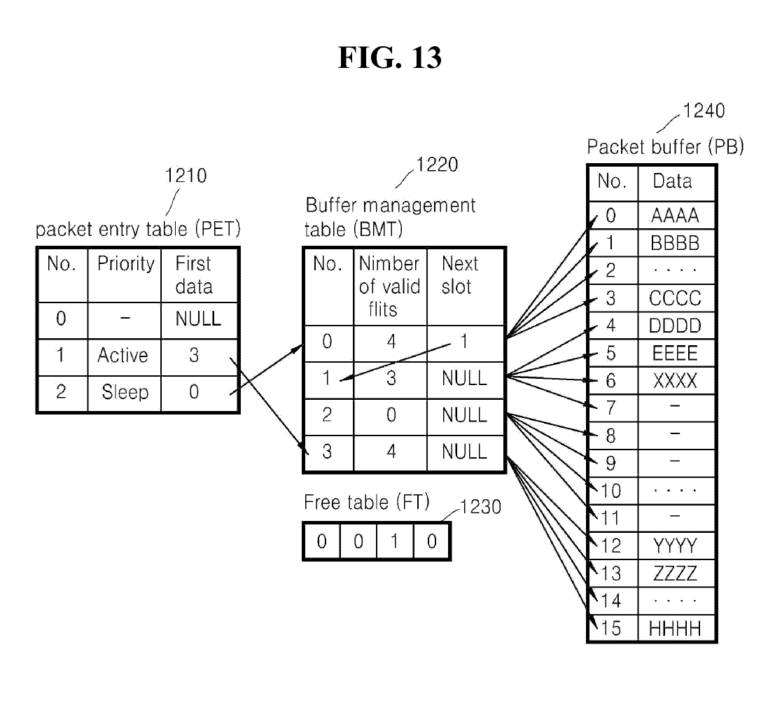

FIG. 13 illustrates an example of a data structure of a request buffer.

Referring to FIG. 13, the request buffer may include 1) packet buffer for storing a payload of a request packet, 2) pointer buffer management table including a position of the first flit of the packet buffer, number of valid flits and the next slot entry corresponding to the next pointer, and 3) packet entry table including priority of request packet and a position of the first flit of the buffer management table.

In detail, the request buffer is basically structured based on the linked list. The request buffer may include a dual port SRAM block for a packet buffer storing payloads of packets.

The buffer management table (BMT) may be implemented by registers used for implementing a linked list structure. For example, each row of the BMT corresponds to 4 entries of the packet buffer (PB). The BMT has two columns of number of valid flits and next slot. Here, ‘number of valid flits’ specifies the number of flits in rows of PB and corresponds to a valid BMT row. ‘next slot’ specifies which BMT includes content following the valid BMT row. In other words, the next slot entry corresponds to the next point in the linked list. If the entry is the end of the packet, the next slot includes a null value specifying that no additional flit exists in the packet. Additionally, a free table (FT) is provided to record that empty slots exists in the BMT. The FT is used for fast memory allocation.

For packet management, a packet entry table (PET) labeled another table is provided. The PET includes priority of each packet and a position of first flit of the packet. In the illustrated embodiment, there are three priority types: active, rejected and sleep.

Whenever a request packet enters the request buffer, an active packet is first executed. Once the active packet is re-queued in the request buffer by the AMP (for example, by failing in LDRNB or branching to A_RETRY), the priority is turned into ‘rejected.’ If the active packet is branched to A_SLEEP to be rearranged, the priority is turned into ‘sleep.’

The active packet has higher priority than the rejected packet. A sleeping packet is not scheduled and is turned into ‘active’ when the AMP is branched to A_WAKE. For example, the data shown in FIG. 13 is structured to have 2 packets. The first packet (in slot 1 of PET) includes 4 flits having ‘active’ priority (in slots 12 to 15 of PB). The second packet (in slot 2 of PET) has ‘sleep’ priority and includes 7 flits queued in slots 0 to 6 of PB.

In addition, the operations of the network-on chip system including AMP according to an embodiment of the present invention can also be embodied as computer readable code on a computer-readable recording medium. The computer-readable recording medium is any data storage device that can store data which can be thereafter read by a computer system. Examples of computer-readable media include read-only memory (ROM), random access memory (RAM), compact disk read-only memory (CD-ROM), magnetic tape, floppy disks, optical data storage devices and so on. The computer-readable media can also be distributed over network coupled computer systems so that the computer readable code is stored and executed in a distributed fashion.

Although exemplary embodiments of the present invention have been described in detail hereinabove, it should be understood that many variations and modifications of the basic inventive concept herein described, which may appear to those skilled in the art, will still fall within the spirit and scope of the exemplary embodiments of the present invention as defined by the appended claims.

### INDUSTRIAL APPLICABILITY OF THE INVENTION

The present invention can be applied to electronic industry using an active memory processor, but aspects of the present invention are not limited thereto.

What is claimed is:

1. A network-on-chip system comprising:
a plurality of processing elements that request to perform an active memory operation for a predetermined operation from a shared memory to reduce access latency of the shared memory; and
an active memory processor connected to the processing elements through a network, storing codes for processing custom transaction in request to the active memory operation, performing an operation addresses or data stored in a shared cache memory or the shared memory based on the codes and transmitting the performed operation result to the processing elements.

2. The network-on-chip system of claim 1, wherein the processing element requests for the active memory operation by generating a request packet including a network address of the active memory processor to execute the active memory operation, a network address of a processing element having requested the active memory operation, a start address of a subroutine code for executing the active memory operation, and a parameter used as argument related to the subroutine code to be executed, and transmitting the generated request packet to the active memory processor.

3. The network-on-chip system of claim 2, wherein the active memory processor receives the request packet, executes the active memory operation using the code start address and the parameter and generates a response packet including information on the execution result of the active memory operation to then transmit the response packet to the processing element.

4. The network-on-chip system of claim 3, wherein the active memory processor further includes a code memory for storing subroutine codes for executing the active memory operation, a request buffer for queuing a request for the active memory operation received from the processing element, and a response buffer for buffering the response packet and transmitting the buffered response packet to the processing element.

5. The network-on-chip system of claim 4, wherein when an immediate response to the result of the active memory operation is not received from the shared cache memory, the active memory processor determines whether or not data for executing the active memory operation is written in the shared cache memory and whether or not the response data for the result of the active memory operation is generated, and cancels execution of the active memory operation based on the determination result.

6. The network-on-chip system of claim 5, wherein when the execution of the active memory operation is cancelled, the active memory processor returns the request for the active memory operation to the request buffer.

7. The network-on-chip system of claim 4, wherein the request buffer comprises:
a packet buffer for queuing a payload of the request packet;
a pointer buffer management table including a position of a first flit of the packet buffer, the number of valid flits and the next slot entry corresponding to the next pointer; and
a packet entry table including a priority of the request packet and a position of a first flit of the pointer buffer management table.

8. The network-on-chip system of claim 1, wherein the processing elements include private cache memories, and when a private cache miss occurs, the private cache memories makes a request for an active memory operation for processing the private cache miss to the active memory processor and receives the private cache missed data by the operation of the active memory processor.
